(19) United States
(12) Patent Application Publication
(10) Pub. No.: US 2021/0018424 A1
(43) Pub. Date: Jan. 21, 2021

(54) MICROCHIP, MICROPARTICLE MEASURING DEVICE, AND MICROPARTICLE MEASURING METHOD

(71) Applicant: Sony Corporation, Tokyo (JP)

(72) Inventors: Junji Kajihara, Tokyo (JP); Yoshiki Okamoto, Kanagawa (JP)

(73) Assignee: Sony Corporation, Tokyo (JP)

(21) Appl. No.: 17/042,858

(22) PCT Filed: Apr. 2, 2019
(86) PCT No.: PCT/JP2019/014595

§ 371 Date: Sep. 28, 2020

(30) Foreign Application Priority Data
Apr. 5, 2018 (JP) 2018-073048

(51) Int. Cl. G01N 15/14; B01L 3/00; B03C 5/02

(52) U.S. Cl. CPC G01N 15/1459; G01N 2015/1006; B03C 5/026; B01L 3/502715

(57) ABSTRACT

There is provided a microchip including a plurality of substrate layers having a flow path in which a liquid containing microparticles flows in at least one of the substrate layers, the microchip at least including: an optical radiation region in which light is radiated to microparticles contained in a fluid flowing in the flow path from a side surface of the substrate layers.

### CROSS REFERENCE TO RELATED APPLICATIONS

This application claims the benefit of Japanese Priority Patent Application JP 2018-073048 filed Apr. 5, 2018, the entire contents of which are incorporated herein by reference.

### TECHNICAL FIELD

The present technology relates to a microchip, a microparticle measuring device, and a microparticle measuring method.

### BACKGROUND ART

A technology called flow cytometry is currently used for analysis of microparticles related to a field of living organisms such as cells and microorganisms. Flow cytometry is an analytical method of analyzing and sorting microparticles by radiating light to microparticles that flow to be contained in a sheath flow feeding a liquid in a flow path and detecting fluorescence or scattered light emitted from the individual microparticles. A device used in such flow cytometry is called a flow cytometer (which may also be called a “cell sorter”).

In this flow cytometer, a microchip in which regions and flow paths for performing a chemical or biological analysis are provided on a substrate of silicon or glass is used. An analysis system through use of such a microchip is referred to as a micro-total-analysis system (μ-TAS), a lab-on-a-chip, a biochip, or the like.

As an exemplary application of μ-TAS to a microparticle measurement technology, there is a microparticle measuring device that optically, electrically, or magnetically measures properties of microparticles in a flow path or region provided on a microchip. A flow cytometer (microchip type flow cytometer) to which such μ-TAS has been applied is advantageous in that cross-contamination of samples between measurements can be prevented by configuring a flow path system with a microchip that enables disposable use.

For example, PTL 1 discloses “a microchip including a main flow path in which a liquid containing microparticles flows and a sorting flow path in which a capturing chamber into which the microparticles are captured and a pressure chamber in which a negative pressure occurs are arranged, the sorting flow path communicating with the main flow path, in which a vertical section with respect to a flow direction of the liquid in the capturing chamber and the pressure chamber is formed to be larger than a vertical section with respect to the flow direction of the liquid in other portions of the sorting flow path”.

### CITATION LIST

### Patent Literature

PTL 1: JP 2017-58375A

### SUMMARY

### Technical Problem

However, it is known that, in the case of a device in which an excitation system and a fluorescence detection system in related art share an objective lens, autofluorescence of the objective lens caused by strong excitation light leaks into the fluorescence detection system to be one of causes that deteriorate the S/N ratio.

Thus, it is mainly desirable to provide a technology that can improve the detection accuracy in flow cytometry.

### Solution to Problem

Firstly, according to an embodiment of the present technology, there is provided a microchip including a plurality of substrate layers having a flow path in which a liquid containing microparticles flows in at least one of the substrate layers, the microchip at least including: an optical radiation region in which light is radiated to microparticles contained in a fluid flowing in the flow path from a side surface of the substrate layers.

In the microchip according to an embodiment of the present technology, an optical detection region in which light can be detected on a side surface opposite to the side surface of the substrate layers may be further included. In this case, a bonding surface of the plurality of substrate layers may be formed so as to avoid the optical detection region.

In addition, in the microchip according to an embodiment of the present technology, the optical radiation region may be provided on one side of a bonding surface of the plurality of substrate layers.

Furthermore, in the microchip according to an embodiment of the present technology, a notch around the optical radiation region and/or the optical detection region in a surface of the microchip may be further included. In this case, the notches may be provided to the left and right in the surface of the microchip. In addition, in this case, the notches provided to the left and right may be asymmetric with respect to a central line of a front surface of the microchip.

Additionally, in the microchip according to an embodiment of the present technology, a reflection structure that reflects forward scatter may be further internally included. In this case, the reflection structure may be a structure having a mirror on a side surface opposite to the side surface from which light is radiated. In addition, in this case, the mirror may have a structure adapted to a predetermined scattering angle light ray.

In addition, according to an embodiment of the present technology, there is provided a microparticle measuring device at least including: a light radiation unit configured to radiate light from a side surface of a microchip including a plurality of substrate layers having a flow path in which a liquid containing microparticles flows in at least one of the substrate layers, the microchip at least including an optical radiation region in which light is radiated to microparticles contained in a fluid flowing in the flow path from a side surface of the substrate layers; and a detection unit configured to detect light from the microparticles.

In the microparticle measuring device according to an embodiment of the present technology, the light radiation unit may radiate light to a side surface that is in parallel with a flow direction of the flow path in the microchip.

In addition, in the microparticle measuring device according to an embodiment of the present technology, the detection unit may include a forward scatter detection unit configured to detect forward scatter, and a fluorescence detection unit configured to detect fluorescence, the forward scatter detection unit may be positioned in a direction identical to the side surface of the microchip, and the fluorescence detection unit may be positioned in a direction different from the side surface of the microchip. In this case, the forward scatter detection unit and the fluorescence detection unit may be positioned in directions different by approximately 90 degrees with respect to the side surface of the microchip.

Furthermore, in the microparticle measuring device according to an embodiment of the present technology, the detection unit may include a forward scatter detection unit configured to detect forward scatter, and a fluorescence detection unit configured to detect fluorescence, and the forward scatter detection unit and the fluorescence detection unit may be positioned in a direction different from the side surface of the microchip. In this case, the microchip may further internally include a reflection structure that reflects forward scatter, and the forward scatter detection unit may detect the forward scatter reflected by the reflection structure.

Furthermore, according to an embodiment of the present technology, there is provided a microparticle measuring method at least including: radiating light from a side surface of a microchip including a plurality of substrate layers having a flow path in which a liquid containing microparticles flows in at least one of the substrate layers, the microchip at least including an optical radiation region in which light is radiated to microparticles contained in a fluid flowing in the flow path from a side surface of the substrate layers; and detecting light from the microparticles.

In the present technology, “microparticle” can include a wide range of biological microparticles such as cells, microorganisms, and liposomes, synthetic particles such as latex particles, gel particles, and industrial particles, and the like.

Biological microparticles include chromosomes, liposomes, mitochondria, organelles (cell organelles) composing various cells, and the like. Cells include animal cells (e.g., hemocyte cells, etc.) and plant cells. Microorganisms include bacteria such as Escherichia coli, viruses such as tobacco mosaic virus, fungi such as yeast, and the like. Furthermore, biological microparticles also include biological polymers such as nucleic acids, proteins, complexes thereof, and the like. In addition, industrial particles may be of, for example, organic or inorganic polymeric materials, metals, and the like. Organic polymeric materials include polystyrene, styrene/divinylbenzene, polymethyl methacrylate, and the like. Inorganic polymeric materials include glass, silica, magnetic materials, and the like. Metals include gold colloid, aluminum, and the like. Although the shapes of these microparticles are normally spherical, non-spherical shapes may be possible, and a size, mass, and the like are not particularly limited in the present technology.

### Advantageous Effects of Invention

According to an embodiment of the present technology, it is possible to provide a technology that can improve the detection accuracy in flow cytometry.

Note that effects described here are not necessarily limiting, and any effect described in the present disclosure may be admitted.

### BRIEF DESCRIPTION OF DRAWINGS

FIG. 1 is a top view showing a first embodiment of a microchip according to the present technology.

FIG. 2 is a perspective view showing the microchip of the embodiment shown in FIG. 1 and a pressure adjustment unit.

FIG. 3 is a sectional view taken along the line Q-Q in FIG. 1.

FIG. 4 shows diagrams describing a configuration of a branch portion of a main flow path and a sorting flow path formed in the microchip of the embodiment shown in FIG. 1.

FIG. 5 is a diagram describing a configuration of a sheath liquid inlet side end of a sheath liquid bypass flow path formed in the microchip of the embodiment shown in FIG. 1.

FIG. 6 is a diagram describing a configuration of an outlet side end of the sheath liquid bypass flow path formed in the microchip of the embodiment shown in FIG. 1.

FIG. 7A is a diagram showing an example of a structure around an optical detection region seen from a side surface of the microchip, and B is a sectional view around the optical detection region.

FIG. 8A is a diagram, different from FIG. 7, showing an example of a structure around the optical detection region seen from a side surface of the microchip, and B is a sectional view around the optical detection region.

FIG. 9A is a top view showing a second embodiment of a microchip according to the present technology, and B is a sectional view around the optical radiation region and the optical detection region.

FIG. 10A is a top view showing a third embodiment of a microchip according to the present technology, B is a diagram showing an example of a sectional view around a mirror, and C is a diagram, different from B, showing an example of a sectional view around the minor.

FIG. 11 shows diagrams describing functions of a pressure adjustment unit.

FIG. 12 is a diagram describing a flow of samples and a sheath liquid that may occur at the branch portion of the main flow path and a branched flow path.

FIG. 13 shows diagrams describing a flow of the sheath liquid introduced via an outlet of the sorting flow path.

FIG. 14 shows diagrams describing a drawn position of a targeted sample at the time of a sorting operation.

FIG. 15 is a top view showing a fourth embodiment of a microchip according to the present technology.

FIG. 16 is a schematic view schematically showing the first embodiment of a microparticle measuring device 10 according to the present technology.

FIG. 17 is a schematic view schematically showing the second embodiment of the microparticle measuring device 10 according to the present technology.

### DESCRIPTION OF EMBODIMENTS

Preferred embodiments for implementing the present technology will be described below with reference to the drawings. The embodiments described below show examples of a representative embodiment of the present technology, and the scope of the present technology is not narrowly interpreted thereby. Note that description will be provided in the following order.

1. Microchip 1

2. Microparticle measuring device 10

### First Embodiment

(1) Light radiation unit 101

(2) Detection unit 102

(3) Others

### Second Embodiment

3. Microparticle measuring method

(1) Light radiation step

(2) Detection step

1. Microchip 1

A microchip 1 (also referred to herein as a microfluidic device) according to an embodiment of the present technology includes a microfluidic structure including a plurality of substrate layers having a flow path in which a liquid containing microparticles flows in at least one of the substrate layers, and at least includes an optical radiation region 115a in which light is radiated to the microparticles contained in a fluid flowing in the flow path from a side surface of the substrate layers. Hereinafter, the microchip 1 according to an embodiment of the present technology will be described in detail with reference to the drawings.

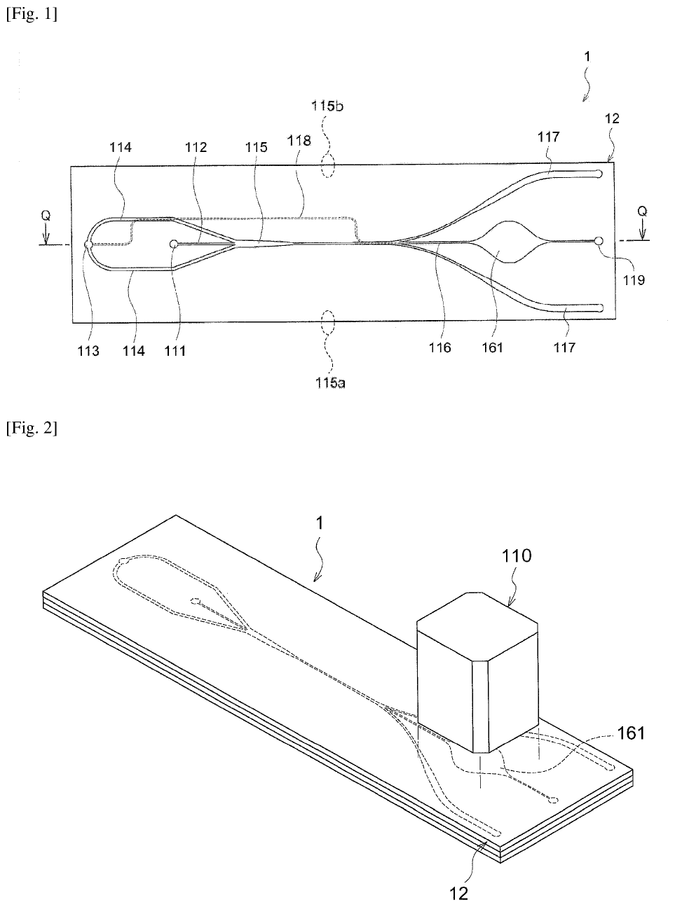

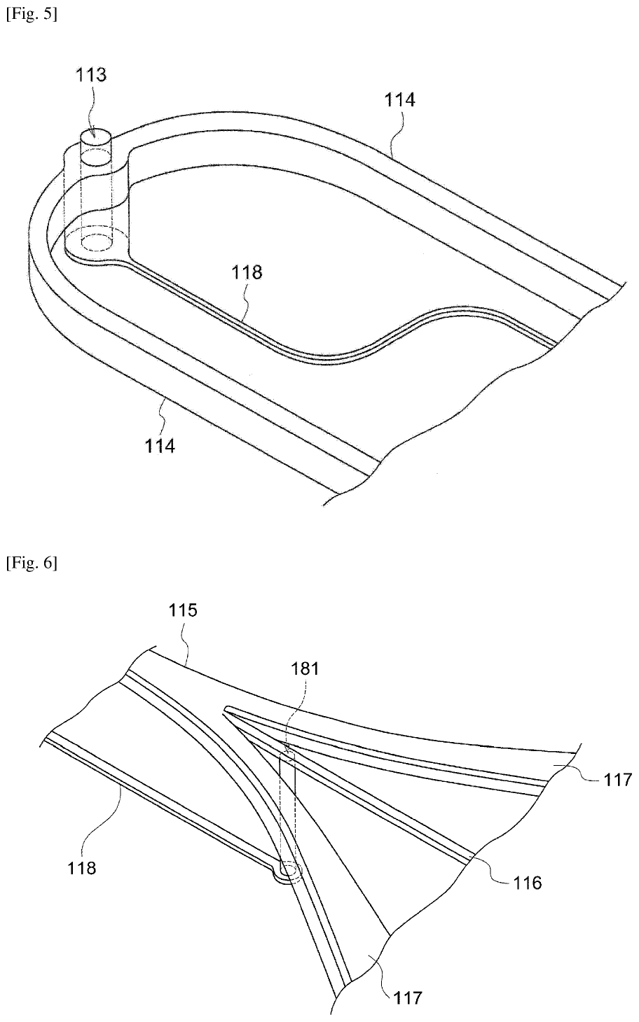

In the microchip 1 of the embodiment shown in FIG. 1, a liquid (hereinafter also referred to as a “sample”) containing microparticles to be targeted for sorting is introduced into a sample flow path 112 via a sample inlet 111. In addition, a sheath liquid is introduced via a sheath liquid inlet 113. The sheath liquid introduced via the sheath liquid inlet 113 is divided into and fed along two sheath liquid flow paths 114. The sample flow path 112 and the two sheath liquid flow paths 114 join to be a main flow path 115. A sample layer flow S fed along the sample flow path 112 and a sheath liquid layer flow T fed along the sheath liquid flow path 114 join within the main flow path 115 to form a sheath flow in which the sample layer flow is interposed between the sheath liquid layer flows (see C of FIG. 4 which will be described later).

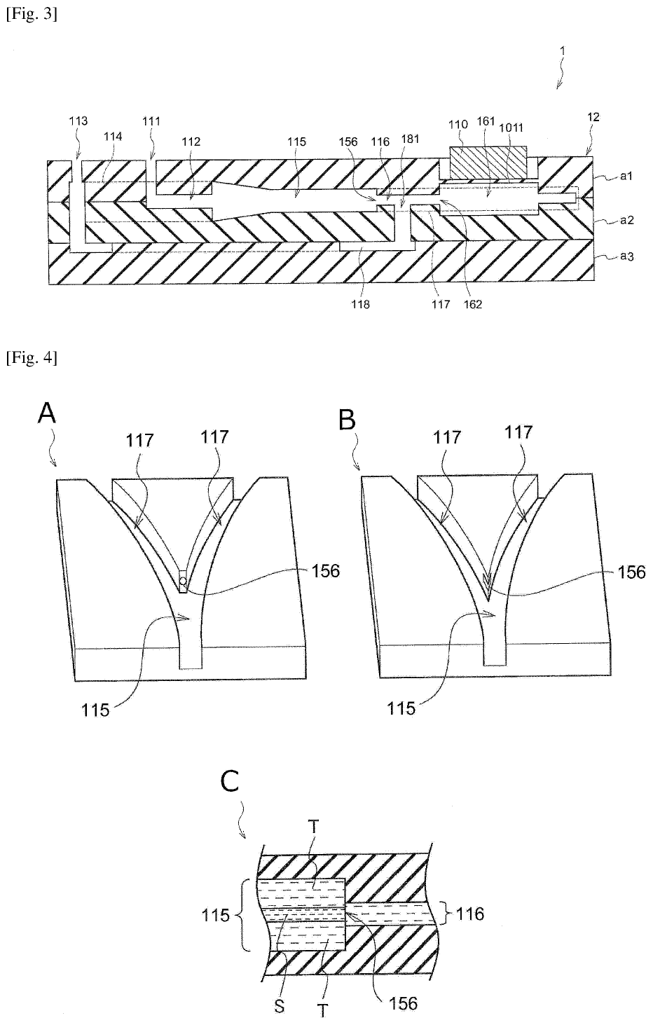

In addition, the sheath liquid introduced via the sheath liquid inlet 113 is also fed to a sheath liquid bypass flow path 118 formed separately from the sheath liquid flow paths 114. The sheath liquid bypass flow path 118 has one end connected to the sheath liquid inlet 113, and the other end connected to the vicinity of a communicating opening of a sorting flow path 116 which will be described later toward the main flow path 115 (see FIG. 3). It is sufficient if a sheath liquid introducing end of the sheath liquid bypass flow path 118 is connected to any position in a sheath liquid flow section including the sheath liquid inlet 113 and the sheath liquid flow paths 114, and preferably connected to the sheath liquid inlet 113. By connecting the sheath liquid bypass flow path 118 to the central position (that is, the sheath liquid inlet 113 in the present embodiment) at which the two sheath liquid flow paths 114 are geometrically symmetric, the sheath liquid can be distributed to the two sheath liquid flow paths 114 at an equal flow rate. The reference character 156 in FIG. 3 indicates the communicating opening of the sorting flow path 116 toward the main flow path 115, and the reference character 181 indicates an outlet of the sheath liquid fed along the sheath liquid bypass flow path 118 toward the sorting flow path 116.

The main flow path 115 is branched into three flow paths downstream of the main flow path 115. A configuration of a branch portion of the main flow path 115 is shown in FIG. 4. The main flow path 115 is in communication with the three branched flow paths including the sorting flow path 116 and two disposal flow paths 117 downstream of the main flow path 115. Among them, the sorting flow path 116 is a flow path into which a targeted microparticle (hereinafter also referred to as a “targeted sample”) is captured. A sample (hereinafter also referred to as an “untargeted sample”) other than the targeted sample flows into either one of the two disposal flow paths 117 without being captured into the sorting flow path 116.

The sheath liquid bypass flow path 118 is connected to an outlet 181 provided to be positioned in the vicinity of the communicating opening 156 of the sorting flow path 116 toward the main flow path 115 (see FIG. 3). The sheath liquid introduced via the sheath liquid inlet 113 is introduced into the sorting flow path 116 via the outlet 181 to form, at the communicating opening 156, a flow of the sheath liquid flowing from the sorting flow path 116 side to the main flow path 115 side (this flow will be described later).

The microchip 1 includes three-level substrate layers, for example, and the sample flow path 112, the sheath liquid flow paths 114, the main flow path 115, the sorting flow path 116, and the disposal flow paths 117 are formed by a first-level substrate layer a1 and a second-level substrate layer a2 (see FIG. 3). On the other hand, the sheath liquid bypass flow path 118 is formed by the second-level substrate layer a2 and a third-level substrate layer a3. The sheath liquid bypass flow path 118 formed in the substrate layers a2 and a3 connects the sheath liquid inlet 113 and the outlet 181 of the sorting flow path 116 without communicating with the sample flow path 112, the sheath liquid flow paths 114, and the main flow path 115 formed in the substrate layers a1 and a2. The configurations of the sheath liquid inlet 113 side end and the outlet 181 side end of the sheath liquid bypass flow path 118 are shown in FIG. 5 and FIG. 6, respectively.

Note that, in the present technology, the layer structure of the substrate layers of the microchip 1 is not limited to three layers, but four layers or more can also be adopted. In addition, the configuration of the sheath liquid bypass flow path 118 is not limited to the structure in the present embodiment.

Capturing of a targeted sample into the sorting flow path 116 is performed by producing a negative pressure in the sorting flow path 116 by a pressure adjustment unit 110, and sucking the targeted sample into the sorting flow path 116 utilizing this negative pressure. The pressure adjustment unit 110 is a piezoelectric element such as a piezo element, for example. The pressure adjustment unit 110 is arranged at a position corresponding to the sorting flow path 116. More specifically, the pressure adjustment unit 110 is arranged at a position corresponding to a pressure chamber 161 provided as a region having an expanded inner space in the sorting flow path 116 (see FIG. 2 and FIG. 3). The pressure chamber 161 is provided downstream of the communicating opening 156 and the outlet 181 in the sorting flow path 116.

The inner space of the pressure chamber 161 is expanded in the plane direction (the width direction of the sorting flow path 116) as shown in FIG. 1, and is also expanded in the sectional direction (the height direction of the sorting flow path 116) as shown in FIG. 3. That is, the sorting flow path 116 has been expanded in the width direction and the height direction in the pressure chamber 161. In other words, the sorting flow path 116 is formed such that the vertical section with respect to the flow direction of the sorting targeted sample and the sheath liquid becomes large in the pressure chamber 161.

The pressure adjustment unit 110 generates a stretching force along with a change in an applied voltage to produce a pressure change in the sorting flow path 116 via the surface (contact surface) of the microchip 1. When a flow occurs in the sorting flow path 116 along with the pressure change in the sorting flow path 116, the volume in the sorting flow path 116 changes at the same time. The volume in the sorting flow path 116 changes until reaching a volume defined by the amount of displacement of the pressure adjustment unit 110 corresponding to the applied voltage. More specifically, in a state extended by the application of a voltage, the pressure adjustment unit 110 presses a displacement plate 1011 (see FIG. 3) that constitutes the pressure chamber 161 to maintain the pressure chamber 161 at a small volume. Then, when the applied voltage drops, the pressure adjustment unit 110 generates a negative pressure in the pressure chamber 161 by generating a force in a contracting direction to weaken the pressure on the displacement plate 1011.

In order to efficiently transmit the stretching force of the pressure adjustment unit 110 into the pressure chamber 161, it is preferable to recess the surface of the microchip 1 at a position corresponding to the pressure chamber 161, and to arrange the pressure adjustment unit 110 in the recess, as shown in FIG. 3. Accordingly, the displacement plate 1011 to be a contact surface of the pressure adjustment unit 110 can be made thin, so that the displacement plate 1011 can be easily displaced by a change in compressive force along with expansion and contraction of the pressure adjustment unit 110 to bring about a volume change of the pressure chamber 161.

In FIG. 3 and FIG. 4, the reference character 156 indicates a communicating opening of the sorting flow path 116 toward the main flow path 115. A targeted sample carried in the sheath flow formed in the main flow path 115 is captured into the sorting flow path 116 via the communicating opening 156. In order to facilitate capturing the targeted sample into the sorting flow path 116 from the main flow path 115, it is preferable that the communicating opening 156 is formed at a position corresponding to the sample layer flow S in the sheath flow formed in the main flow path 115, as shown in C of FIG. 4. The shape of the communicating opening 156 is not particularly limited, but the shape opened in a plane as shown in A of FIG. 4, the shape formed by cutting the flow path wall of the two disposal flow paths 117 as shown in B of FIG. 4 to make an opening, or the like can be adopted, for example.

The microchip 1 can be configured by bonding substrate layers in which the main flow path 115 and the like have been formed. The main flow path 115 and the like can be formed in the substrate layers through injection molding of thermoplastic resin through use of a mold. As thermoplastic resin, plastic publicly known in related art as the material of a microchip, such as polycarbonate, polymethylmethacrylate resin (PMMA), cyclic polyolefin, polyethylene, polystyrene, polypropylene, or polydimethylsiloxane (PDMS), can be adopted.

The reference character 115a in FIG. 1 indicates an optical radiation region in which light is radiated from the side surface of the substrate layers to microparticles contained in the fluid flowing in the flow path. The side surface is preferably a side surface that is in parallel with the flow direction of the flow paths in the microchip. Since the microchip 1 includes the optical radiation region 115a, it is possible to radiate light such as excitation light from the side surface of the microchip 1. As a result, forward scatter (FSC) from targeted microparticles can be acquired at the opposite side surface or the front surface side of the microchip 1. In addition, a fluorescent signal (FL) and side scatter (SSC) can be acquired from the front surface side of the microchip 1. Accordingly, it is no longer necessary for the device side to have a configuration in which the excitation system and the fluorescence detection system share an objective lens, and it is possible to prevent autofluorescence of the objective lens caused by strong excitation light from leaking into the fluorescence detection system, and to avoid a phenomenon such as deterioration of the S/N ratio, so that the measuring accuracy can be improved.

The reference character 115b in FIG. 1 indicates an optical detection region in which light can be detected, the optical detection region being located in the opposite side surface of the side surface of the substrate layers. In the optical detection region, excitation light is radiated, and detection of light such as fluorescence and scattered light emitted from samples is performed. The samples are carried in a state arrayed in a line in the sheath flow formed in the main flow path 115, and are radiated with the excitation light. By including this optical detection region 115b, light such as fluorescence and scattered light resulting from light such as excitation light radiated to the optical radiation region 115a is made possible, so that the measuring accuracy can be improved further.

As shown, for example, in FIGS. 1 and 2, the microfluidic structure includes a top surface and a bottom surface arranged opposite the top surface. For example, the top surface may be the surface shown in FIG. 2 upon which pressure adjustment unit 110 is arranged and the bottom surface may be surface (not shown) arranged opposite to the top surface. The microfluidic structure also includes a first side surface arranged between the top and bottom surfaces and a second side surface also arranged between the top and bottom surfaces and further arranged opposite the first side surface. For example, as shown in FIG. 1, the first side surface may be the surface at which optical radiation region 115a is located and the second side surface may be the surface at which optical detection region 115b is located. The optical radiation region 115a (also referred to herein as the optical irradiation region) and the optical detection region 115b are included in an optical measurement region that extends from the first side surface to the second side surface. Within the optical measurement region, light irradiated on the optical irradiation region 115a interacts with microparticles when present in the portion of the flow path 115 also within the optical measurement region.

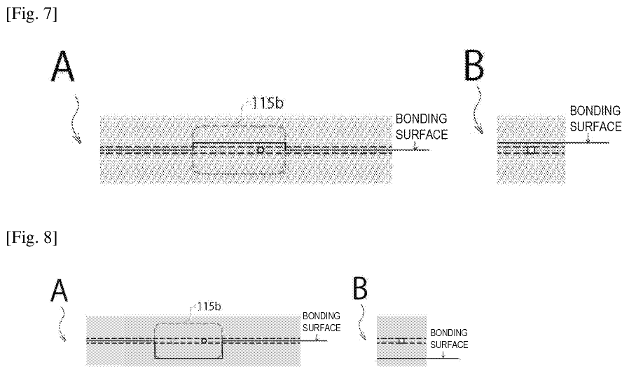

In the present technology, it is preferable that a bonding surface of the plurality of substrate layers extending along a first direction from a first end of the microfluidic structure to a second end of the microfluidic structure is formed so as to avoid the optical detection region 115b as shown in FIG. 7 and FIG. 8. The first direction may be orthogonal to a second direction along which the optical measurement region extends from the first side surface to the second side surface. Note that, in FIG. 7 and FIG. 8, two circles having different colors indicate radiation of two laser beams having different waveforms. The microchip 1 has a multilayer structure obtained by bonding the plurality of substrate layers. In the case where the bonding surface extends through the center of a flow path to which light is radiated as viewed from the chip side surface, reflection and scattering at the bonding surface will lower the quality of a detection signal. Therefore, by forming the bonding surface of the plurality of substrate layers so as to avoid the optical detection region 115b, it is possible to prevent the above-described reflection and scattering, and to avoid inhibition of transmission of light such as fluorescence and scattered light, so that the measuring accuracy can be improved.

Note that, in the case where a plurality of bonding surfaces exists in the microchip 1, the optical detection region 115b may be provided between the bonding surfaces.

In addition, it is preferable to provide the optical radiation region 115a on one side of the bonding surface of the plurality of substrate layers. Accordingly, it is possible to avoid inhibition of radiation of excitation light since the bonding surface of the plurality of substrate layers lowers the quality of a detection signal as described earlier, so that the measuring accuracy can be improved.

Note that, in the case where a plurality of bonding surfaces exists in the microchip 1, only the part of the optical radiation region 115a may have a two-layer structure.

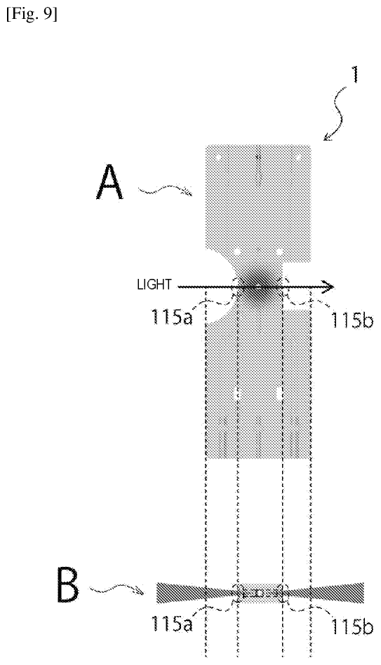

In the present technology, it is preferable to further provide notches around the optical radiation region 115a and/or the optical detection region 115b on the surface of the microchip 1 as shown in FIG. 9. Even in the case where the bonding surface of the plurality of substrate layers avoids the optical detection region 115b, the beam diameter is large before reaching the focal position, and thus, the influence of the bonding surface may be exerted. Therefore, notches are provided around the optical radiation region 115a and/or the optical detection region 115b to cause light to enter the chip in a state of small-diameter beam that is less likely to be affected, so that the measuring accuracy can be improved.

The shape of the notches is not particularly limited, but can be rectangular, semi-circular, or the like. The size of the notches is also not particularly limited, but in the case where the front surface side of the microchip 1 has a width of 25 mm, for example, the notches can have a width of 2 to 3 mm.

In addition, it is preferable to provide the notches in the surface of the microchip 1 to the left and right as shown in FIG. 9. Accordingly, it is possible to make the above-described influence less likely to be exerted, so that the measuring accuracy can be improved further.

In addition, these notches provided to the left and right may be made asymmetric with respect to the central line of the front surface of the microchip 1. Accordingly, the optical radiation region 115a and the optical detection region 115b can be distinguished by the shape, and usability is improved.

In the present technology, it is preferable to further internally include a reflection structure that reflects forward scatter. Accordingly, it is possible to detect forward scatter, a fluorescent signal, and side scatter through an identical surface (the front surface side of the microchip 1), and the detection system on the device side can be integrated. As a result, the flexibility of space utilization on the device side can be increased.

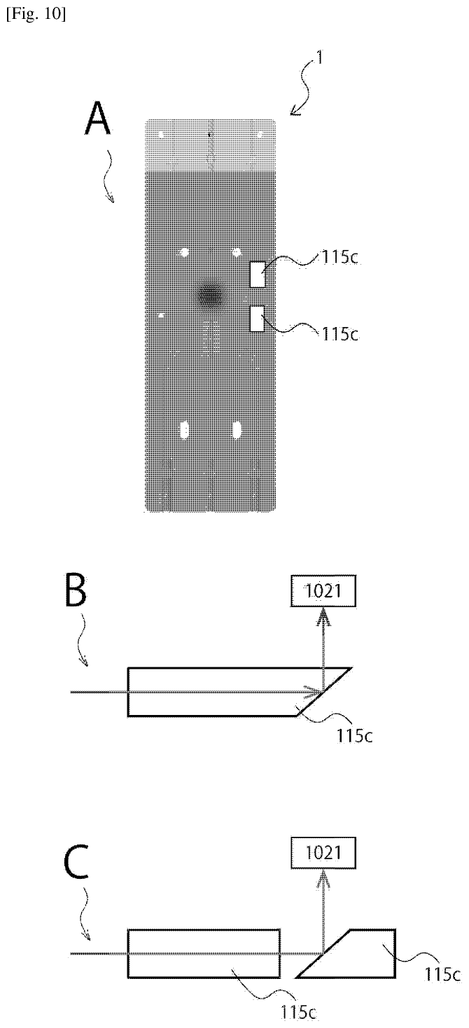

The reflection structure can be a structure having mirrors 115c on a side surface opposite to the side surface to which light is radiated, as shown in A of FIG. 10, for example.

The minors 115c are not particularly limited, but can have a structure adapted to a predetermined scattering angle light ray as shown in B or C of FIG. 10, for example. As a structure adapted to a predetermined scattered light ray, a minor raised in the direction of the sheet can be set for acquiring light having an angle (for example, 6 to 9 degrees) at which forward scatter is acquired, for example. This light is detected by a forward scatter detection unit 1021 which will be described later, for example. Stated differently, the optical measurement region extending from the first side surface to the second side surface of the microfluidic structure may be considered to have a midline along the extended direction, and the minors 115c may be arranged offset from the midline by a predetermined forward scattering angle (e.g., 6 to 9 degrees). Note that the minors 115c may be subjected to AR coating, HR coating, or the like. Note that the number of the minors 115c is two in A of FIG. 10, but is not limited to this in the present technology.

Hereinafter, a sorting operation in the microchip 1 will be described with reference to

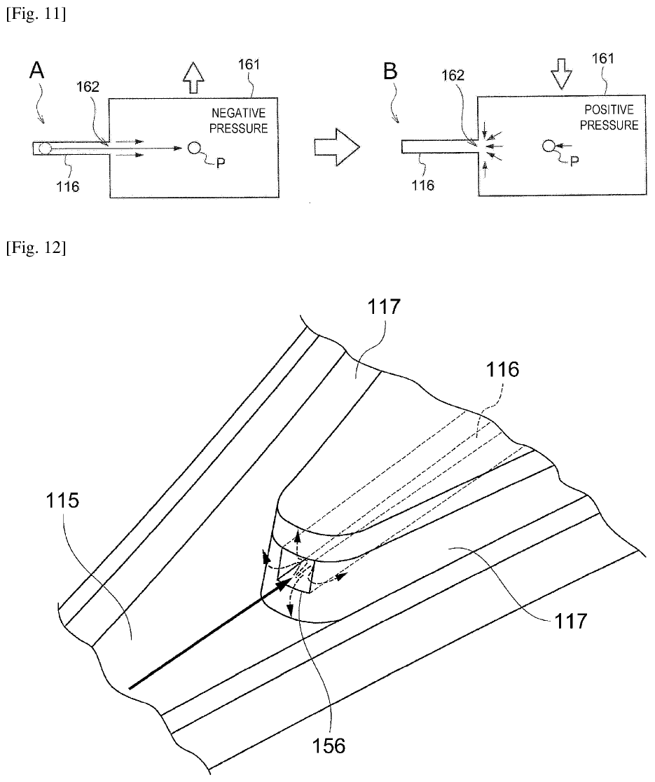

FIG. 11 to FIG. 14.

A targeted sample drawn into the sorting flow path 116 by the pressure adjustment unit 110 is captured into the pressure chamber 161, as shown in A of FIG. 11. In the drawing, the reference character P indicates a targeted sample captured into the pressure chamber 161, and the reference character 162 indicates a capturing inlet of the targeted sample P into the pressure chamber 161. A flow of samples including the targeted sample P and the sheath liquid turns into a jet when flowing into the pressure chamber 161 having an expanded inner space, and is detached from the flow path wall surface (see arrows in A of FIG. 11). Therefore, the targeted sample P moves away from the capturing inlet 162 to be captured farther into the pressure chamber 161.

In order to draw targeted samples into the pressure chamber 161 from the main flow path 115, it is preferable that the amount of increase in volume of the pressure chamber 161 is made larger than the volume of the sorting flow path 116 (see FIG. 3) from the communicating opening 156 to the capturing inlet 162. In addition, it is preferable that the amount of increase in volume of the pressure chamber 161 is such a magnitude that a negative pressure sufficient to detach the flow of samples including the targeted sample P and the sheath liquid from the flow path wall surface at the capturing inlet 162 is produced.

In this manner, by capturing the targeted sample P farther into the pressure chamber 161 whose inner space has been expanded in the sorting flow path 116, it is possible to prevent the targeted sample P from flowing out of the pressure chamber 161 again to the main flow path 115 side even in the case where the pressure within the sorting flow path 116 is reversed to be a positive pressure. That is, as shown in B of FIG. 11, since the samples and sheath liquid flow out widely from the vicinity of the capturing inlet 162 even in the case where the inside of the sorting flow path 116 turns into a positive pressure, the amount of movement of the targeted sample P itself captured to a position away from the capturing inlet 162 decreases. Therefore, the targeted sample P is held within the pressure chamber 161 without flowing out again.

In the pressure chamber 161, it is preferable to prevent an untargeted sample or samples including this and the sheath liquid from intruding into the sorting flow path 116. However, a flow of the samples and sheath liquid (see the solid arrow in FIG. 12) fed along the main flow path 115 has a large momentum as shown in FIG. 12, and thus, may flow into the sorting flow path 116 via the communicating opening 156. The flow of the samples and sheath liquid flown into the sorting flow path 116 via the communicating opening 156 changes the direction within the sorting flow path 116 to flow out to the main flow path 115 side along the flow path wall of the sorting flow path 116 (see dotted arrows in FIG. 12).

The flow of the samples and sheath liquid flown out of the sorting flow path 116 to the main flow path 115 side along the flow path wall is restricted by the flow path wall and is slow accordingly, which causes retention of an untargeted sample or samples including this and the sheath liquid at the communicating opening 156. This retention will interfere with performing an operation of sorting a targeted sample and an untargeted sample at high speeds.

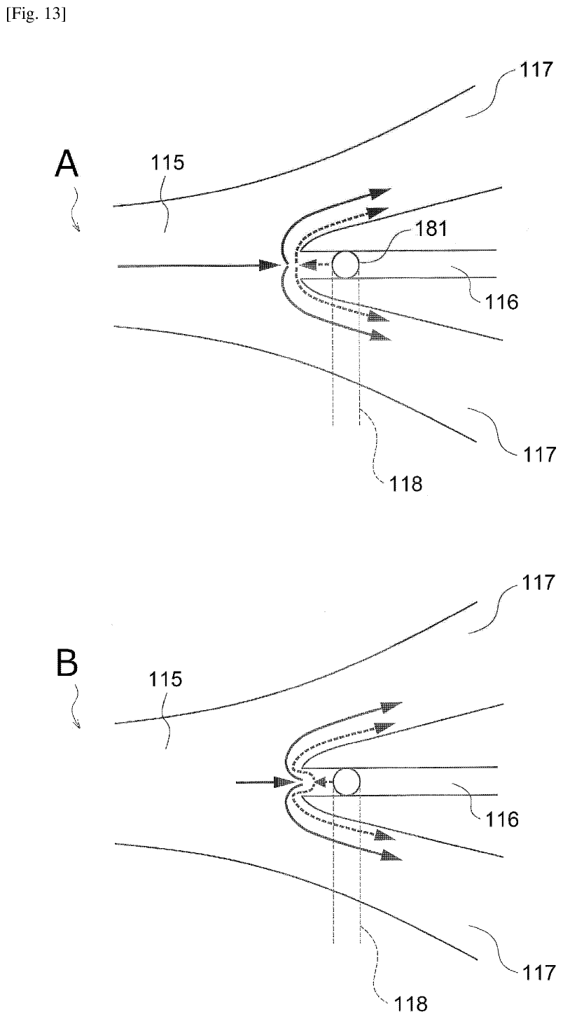

In contrast to this, in the microchip 1, the sheath liquid introduced into the sorting flow path 116 via the outlet 181 by the sheath liquid bypass flow path 118 acts for suppressing an untargeted sample or samples including this and the sheath liquid intruding into the sorting flow path 116 when in a non-sorting operation. That is, the sheath liquid introduced via the sheath liquid inlet 113 is introduced into the sorting flow path 116 via the outlet 181 to form a flow of the sheath liquid from the sorting flow path 116 side to the main flow path 115 side (hereinafter also referred to as a “reverse flow”) at the communicating opening 156 (see A of FIG. 13). Then, this reverse flow counteracts the flow of the samples and sheath liquid which is going to intrude into the sorting flow path 116 from the main flow path 115, so that intrusion of the samples and sheath liquid into the sorting flow path 116 is blocked.

It is preferable that the reverse flow has a momentum that matches a momentum (impulse) of the flow of the samples and sheath liquid which is going to intrude into the sorting flow path 116 from the main flow path 115. The momentum of the reverse flow can be controlled by regulating the amount of feeding of the sheath liquid to the sheath liquid bypass flow path 118, and the amount of feeding can be controlled by regulating the flow path diameter of the sheath liquid bypass flow path 118. In addition, regulation of the amount of feeding can also be performed by a liquid feeding device such as a syringe pump, a valve provided for the sheath liquid bypass flow path 118, or the like.

The flow ratio between the flow rate of the sheath liquid introduced into the sheath liquid flow path 114 via the sheath liquid inlet 113 and the flow rate into the bypass flow path 118 is determined by a flow path resistance ratio between both the flow paths. Therefore, the above-described flow ratio does not vary even if an introduction pressure of the sheath liquid into the sheath liquid inlet 113 varies, so that a stable operation is possible. In addition, even in the case where the necessity to change the flow rate of the sheath liquid arises in order to change the flowing speed of samples in the sorting flow path 116, it is not necessary to individually control the flow rate into the sheath liquid flow path 114 and the flow rate into the sheath liquid bypass flow path 118.

It is preferable that the momentum of the reverse flow has a magnitude that can completely suppress intrusion of the samples and sheath liquid into the sorting flow path 116 from the main flow path 115. However, the reverse flow does not necessarily completely suppress the above-described intrusion, but it is sufficient if the above-described intrusion is reduced to some degree. As described above, when the flow of the samples and sheath liquid flowing out of the sorting flow path 116 to the main flow path 115 side along the flow path wall occurs, retention of an untargeted sample or samples including this and the sheath liquid at the communicating opening 156 is caused. As shown in B of FIG. 13, if intrusion of the samples and sheath liquid into the sorting flow path 116 from the main flow path 115 can be reduced to some degree, the flow of the samples and sheath liquid flowing out of the sorting flow path 116 to the main flow path 115 side along the flow path wall which will cause the retention can be suppressed.

Note that, by suppressing retention of an untargeted sample or samples including this and the sheath liquid at the communicating opening 156, it is also possible to prevent targeted samples and untargeted samples from adhering to the flow path wall.

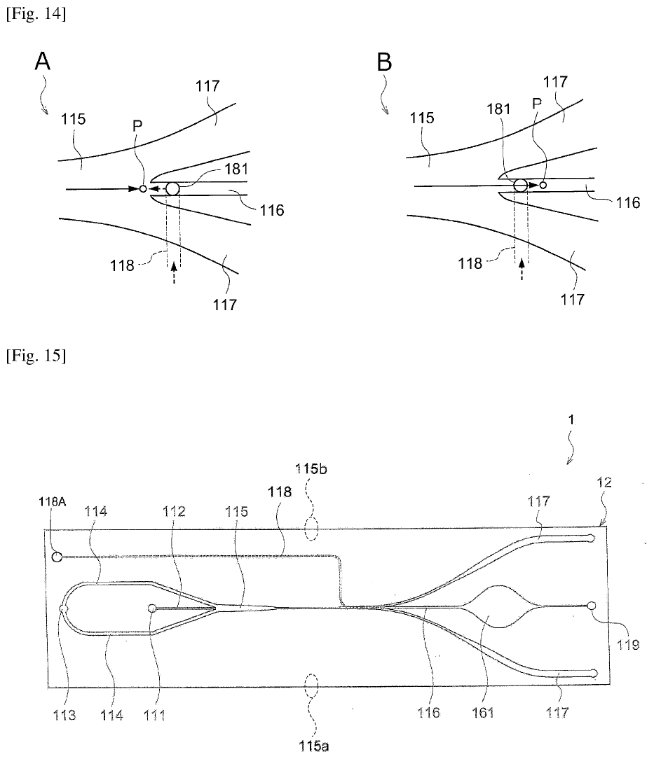

The reverse flow is also formed at the communicating opening 156 when drawing targeted samples into the sorting flow path 116 (see A of FIG. 14). Therefore, when in the sorting operation, it is desirable to draw targeted samples into the sorting flow path 116 at a drawing pressure exceeding the reverse flow (see B of FIG. 14). The amount of increase in volume of the pressure chamber 161 shall have a magnitude sufficient to produce a drawing pressure exceeding the reverse flow.

Further, it is desirable that targeted samples be drawn to a position beyond the outlet 181 in the sorting flow path 116, as shown in B of FIG. 14. If drawing into the sorting flow path 116 is insufficient, the targeted samples may flow out again into the main flow path 115 because of the reverse flow formed by the sheath liquid introduced into the sorting flow path 116 via the outlet 181 by the sheath liquid bypass flow path 118.

In order to draw targeted samples sufficiently to a position beyond the outlet 181, the amount of increase in volume of the pressure chamber 161 shall be larger than the flow rate of the reverse flow, and the flow rate of the samples and sheath liquid sucked into the sorting flow path 116 from the main flow path 115 by a negative pressure shall be larger than the flow rate of the reverse flow.

With the microchip 1 formed in this manner, after a desired amount of targeted samples can be captured into the pressure chamber 161, targeted samples are coupled to the pressure chamber 161, and flow to a sorting flow path terminal 119 (see FIG. 1). Note that it is preferable that, considering performing a pressure change of the pressure chamber 161 by the pressure adjustment unit 110, the pressure chamber 161 and the sorting flow path terminal 119 are coupled with an on-off valve or the like.

The microchip 1 of the embodiment of FIG. 1 is configured such that the sheath liquid inlet 113 connects to the sheath liquid bypass flow path 118, whilst an introduction path 118A may be provided separately without connecting the sheath liquid bypass flow path 118 to the sheath liquid inlet 113, as shown in FIG. 15. In this case, it is possible to introduce the sheath liquid via the sheath liquid inlet 113, and on the other hand, to introduce a solution (for example, a culture solution) different from the sheath liquid from the introduction path 118A. Then, the solution introduced from the introduction path 118A passes through the sorting flow path 116, the pressure chamber 161, and the sorting flow path terminal 119.

Therefore, since the introduction path 118A brings about an environment in which the culture solution exists more than the sheath liquid although the sheath liquid may be mixed downstream of the pressure chamber 161, a good environment for targeted samples after sorting collection performed by the microchip 1 can be created automatically.

In addition, in the case where the microchip 1 has a configuration as shown in FIG. 15, it is possible to individually control the flow rate of the sheath liquid bypass flow path 118, and thus, in exchangeable microchips 1, even if there are design differences (for example, in the case where the flow paths vary widely in width and height) between the microchips 1, optimization of sorting conditions taking the design differences between the microchips 1 into account can be carried out by controlling the flow rate of the sheath liquid bypass flow path 118.

A storage unit in which a liquid containing microparticles to be targeted for sorting is stored, a reservoir in which targeted samples are stored, and the like may be connected to the microchip 1 according to an embodiment of the present technology by closed coupling or the like. The storage unit and the reservoir can be formed in a bag form, for example. The microchip 1 to which the storage unit and the reservoir are connected may be distributed as a part of a product, such as a cartridge, a unit, a device, a kit, or an appliance, for a closed cell sorter.

2. Microparticle Measuring Device 10

### First Embodiment

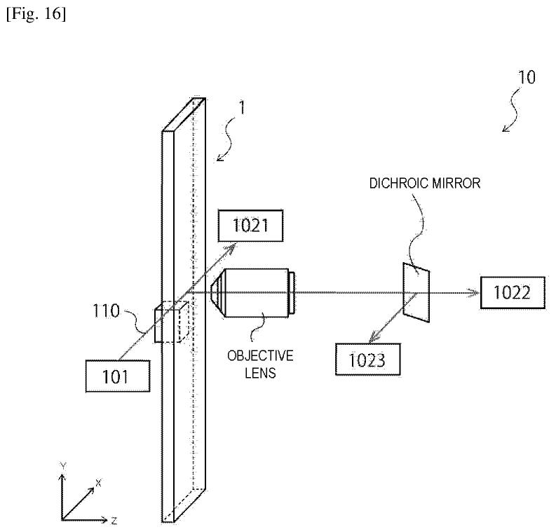

FIG. 16 is a schematic view schematically showing the first embodiment of the microparticle measuring device 10 according to the present technology. The microparticle measuring device 10 according to the present embodiment at least includes a light radiation unit 101 and a detection unit 102. In addition, a processing unit and the like may be included according to necessity. Hereinafter, each unit will be described in detail.

(1) Light Radiation Unit 101

The light radiation unit 101 radiates light from a side surface of the microchip 1 including a plurality of substrate layers having a flow path in which a liquid containing microparticles flows in at least one of the substrate layers, the microchip 1 at least including an optical radiation region in which light is radiated to microparticles contained in a fluid flowing in the flow path from the side surface of the substrate layers. Since the microchip 1 is similar to that described earlier, description will be omitted here.

In the present technology, since it is possible to radiate light from the side surface of the microchip 1, optical paths for detection of excitation light and fluorescence can be separated, and in particular, since a significant reduction of autofluorescence resulting from the objective lens can be expected, the measuring accuracy can be improved. In addition, since a space on the side of a pressure adjustment unit (for example, a piezo element) indicated by the reference character 110 in FIG. 16 can be left widely, the flexibility of space utilization is also improved. In addition, structural flexibility of a sorting driving mechanism is increased, so that restrictions on layout can be canceled. As a result, performance improvement of the sorting driving mechanism is also expected.

The light radiation unit 101 includes a light source that outputs excitation light, an objective lens that condenses excitation light on microparticles flowing in the main flow path 115, and the like. For the light source, a laser diode, an SHG laser, a solid-state laser, a gas laser, a high-brightness LED, or the like is used, for example. In addition, the light radiation unit 101 may have an optical element other than the light source and objective lens according to necessity.

In the microparticle measuring device 10, it is preferable that the light radiation unit 101 radiates light to a side surface that is in parallel with the flow direction of the flow paths in the microchip 1. Accordingly, the measuring accuracy can be improved.

(2) Detection Unit 102

The detection unit 102 detects light from the microparticles. More specifically, the detection unit 102 detects fluorescence, scattered light, and the like produced from the microparticles by radiation of excitation light. The detection unit 102 includes a condensing lens that condenses fluorescence, scattered light, and the like produced from the microparticles, a detector, and the like. For the detector, PMT, photodiode, CCD, CMOS, or the like is used, for example. In addition, the detection unit 102 may have an optical element other than the condensing lens and detector according to necessity.

Fluorescence detected by the detection unit 102 may be fluorescence produced from the microparticles themselves and fluorescence produced from a fluorescent material or the like that labels the microparticles. In addition, scattered light detected by the detection unit 102 may be various types of scattered light, such as forward scatter, side scatter, Rayleigh scattering, Mie scattering, and the like.

In a device in related art, a fluorescence detection system and a forward scatter detection system are opposite with interposition of a wide surface (front surface) of a chip, so that the flexibility of space utilization is lowered. As a result, usability is reduced, and in particular, the structure and layout of the sorting driving mechanism such as the pressure adjustment unit 110 (for example, a piezo element) described earlier are restricted.

In contrast to this, in the present technology, it is preferable that the detection unit 102 includes the forward scatter detection unit 1021 that detects forward scatter and a fluorescence detection unit 1022 that detects fluorescence, and the forward scatter detection unit 1021 is positioned in a direction identical to the side surface of the microchip 1, and the fluorescence detection unit 1022 is positioned in a direction different from the side surface of the microchip 1. Accordingly, it is possible to further improve the spatial flexibility, and the structural flexibility of the sorting driving mechanism increases, so that the restrictions on layout can be canceled. As a result, performance improvement of the sorting driving mechanism is also expected.

The forward scatter detection unit 1021 detects forward scatter produced from the microparticles radiated with light (for example, excitation light) output from the light source. The forward scatter is light scattered from the microparticles radiated with light generally at an angle of 6 to 9 degrees with respect to the optical axis of light from the light source, and information mainly about the size of microparticles is obtained.

In addition, in this case, it is preferable that the forward scatter detection unit 1021 and the fluorescence detection unit 1022 are positioned in directions different by approximately 90 degrees with respect to the side surface of the microchip 1. By configuring in this manner, the detection accuracy can be improved further.

Note that fluorescence and scattered light detected by the detection unit 102 are converted into an electric signal for output to a processing unit or the like. The processing unit determines optical properties of microparticles on the basis of the input electric signal. In addition, for example, the processing unit functions to apply a voltage to the pressure adjustment unit 110, and by controlling the voltage, capture microparticles determined as satisfying predetermined properties into the sorting flow path 116 from the main flow path 115.

(3) Others

Note that, in the present technology, it is also possible to store functions performed in the respective units of the microparticle measuring device 10 according to an embodiment of the present technology in a personal computer or a hardware resource including a control unit including CPU or the like, a recording medium (for example, a nonvolatile memory (for example, a USB memory), HDD, CD, or the like), and the like as programs, and to cause the functions to operate by the personal computer or the control unit.

### Second Embodiment

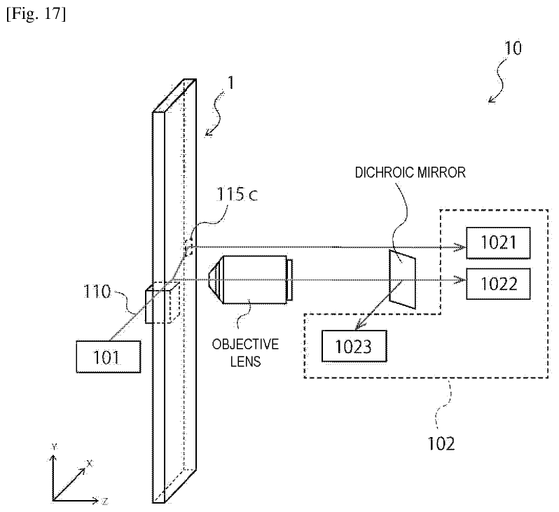

FIG. 17 is a schematic view schematically showing a second embodiment of the microparticle measuring device 10 according to the present technology.

In the present embodiment, the detection unit 102 includes the forward scatter detection unit 1021 that detects forward scatter and the fluorescence detection unit 1022 that detects fluorescence, and the forward scatter detection unit 1021 and the fluorescence detection unit 1022 can be positioned in a direction different from the side surface of the microchip 1. Accordingly, as shown in FIG. 17, the detection system can be integrated in one direction. As a result, the flexibility of space utilization on the device side can be increased.

In addition, in this case, it is possible for the microchip 1 to further internally include a reflection structure that reflects forward scatter, and the forward scatter detection unit 1021 can be a unit that detects the forward scatter reflected by the reflection structure. Since the reflection structure is similar to that described earlier, description will be omitted here.

Note that the configuration and effects other than those described above in the microparticle measuring device 10 of the present embodiment are similar to those of the microparticle measuring device 10 of the first embodiment described earlier.

3. Microparticle Measuring Method

A microparticle measuring method according to an embodiment of the present technology at least performs a light radiation step and a detection step. In addition, other steps may be performed according to necessity. Hereinafter, each step will be described in detail.

(1) Light Radiation Step

In the light radiation step, light is radiated from a side surface of a microchip including a plurality of substrate layers having a flow path in which a liquid containing microparticles flows in at least one of the substrate layers, the microchip at least including an optical radiation region in which light is radiated to the microparticles contained in a fluid flowing in the flow path from the side surface of the substrate layers. Since a specific method performed in the present light radiation step is similar to the method performed in the light radiation unit 101 of the microparticle measuring device 10 described earlier, description will be omitted here.

(2) Detection Step

In the detection step, light from the microparticles is detected. Since a specific method performed in the present detection step is similar to the method performed in the detection unit 102 of the microparticle measuring device 10 described earlier, description will be omitted here.

It should be understood by those skilled in the art that various modifications, combinations, sub-combinations and alterations may occur depending on design requirements and other factors insofar as they are within the scope of the appended claims or the equivalents thereof.

Additionally, the present technology may also be configured as below.

(1)

A microfluidic device, comprising:

a microfluidic structure including a plurality of substrate layers, at least one of which includes a flow path through which a liquid containing microparticles may flow,

wherein the microfluidic structure includes a top surface, a bottom surface arranged opposite the top surface, a first side surface arranged between the top surface and the bottom surface, and a second side surface arranged opposite the first side surface, and

wherein the microfluidic structure includes an optical measurement region that includes an optical irradiation region at the first side surface that allows light irradiated on the optical irradiation region to interact with the microparticles when present in the flow path, a portion of the flow path, and an optical detection region at the second side surface.

(2)

The microfluidic device according to (1), wherein the microfluidic structure includes a first substrate layer and a second substrate layer having a bonding surface at which the first substrate layer and the second substrate layer are bonded, and

wherein the optical measurement region does not include the bonding surface.

(3)

The microfluidic device according to (2), wherein the bonding surface is arranged along a first direction from a first end of the plurality of substrate layers to a second end of the plurality of substrate layers, and

wherein along the first direction, the bonding surface includes at least one notch at the optical measurement region.

(4)

The microfluidic device according to (3), wherein the optical measurement region includes a light transmission path along a second direction orthogonal to the first direction.

(5)

The microfluidic device according to (3), wherein the at least one notch includes a first notch and a second notch, wherein the first and second notches have different shapes.

(6)

The microfluidic device according to (5), wherein the first notch is arranged at the first side surface and the second notch is arranged at the second side surface.

(7)

The microfluidic device according to (2), wherein within the optical measurement region, a thickness of the first substrate layer and/or the second substrate layer along a direction between the top and bottom surfaces is different than the thickness of the first substrate layer and/or the second substrate layer outside of the optical measurement region.

(8)

The microfluidic device according to (1), further comprising:

a reflector arranged to reflect forward scattering light within the optical measurement region.

(9)

The microfluidic device according to (8), wherein the reflector comprises a mirror arranged at the second side surface.

(10)

The microfluidic device according to (9), wherein the mirror is arranged within the microfluidic structure at the second side surface.

(11)

The microfluidic device according to (9), wherein the optical measurement region includes a midline extending from the first side surface to the second side surface, and wherein the mirror is arranged offset from the midline by a predetermined forward scattering angle.

(12)

The microfluidic device according to (1), wherein the microfluidic structure includes a first substrate layer and a second substrate layer having a bonding surface at which the first substrate layer and the second substrate layer are bonded, and

wherein along a direction perpendicular with the top surface, a distance of the bonding surface relative to the top surface changes.

(13)

A microparticle measuring device, comprising:

a light source configured to irradiate light on a first side surface of a microfluidic structure that includes a plurality of substrate layers, at least one of which includes a flow path through which a liquid containing microparticles may flow; and

a detector configured to detect a signal based, at least in part, on an interaction of the light with the microparticles when present in the liquid.

(14)

The microparticle measuring device according to (13), wherein the first side surface is parallel to the flow path in the microfluidic structure.

(15)

The microparticle measuring device according to (13), wherein the detector includes:

a forward scatter detector configured to detect forward scattering light, wherein the forward scatter detector is arranged facing the first side surface; and

a fluorescence detector configured to detect a fluorescence signal, wherein the fluorescence detector is arranged facing a surface of the microfluidic structure different from the first side surface.

(16)

The microparticle measuring device according to (15), wherein the first side surface is arranged between a top surface and a bottom surface of the microfluidic structure, and wherein the forward scatter detector is arranged facing the top surface or the bottom surface.

(17)

The microparticle measuring device according to claim 13, wherein the detector includes:

a forward scatter detector configured to detect forward scattering light, and

a fluorescence detector configured to detect a fluorescence signal, and

wherein the forward scatter detector and the fluorescence detector are arranged facing different surfaces of the microfluidic device.

(18)

The microparticle measuring device according to (17), wherein the microfluidic structure further includes a reflector configured to reflect the forward scattering light, and

wherein the forward scatter detector is configured to detect the forward scattering light reflected by the reflector.

(19)

A microparticle measuring method comprising:

irradiating light on a side surface of a microfluidic structure that includes a plurality of substrate layers, at least one of which includes a flow path through which a liquid containing microparticles may flow; and

detecting a signal based, at least in part, on an interaction of the light with the microparticles when present in the liquid.

### REFERENCE SIGNS LIST

1 microchip

110 pressure adjustment unit

1011 displacement plate

111 sample inlet

112 sample flow path

113 sheath liquid inlet

114 sheath liquid flow path

115 main flow path

115a optical radiation region

115b optical detection region

115c mirror

116 sorting flow path

117 disposal flow path

118 sheath liquid bypass flow path

119 sorting flow path terminal

156 communicating opening of sorting flow path 116 toward main flow path 115

161 pressure chamber

162 capturing inlet of targeted sample P into pressure chamber 161

181 outlet of sheath liquid fed along sheath liquid bypass flow path 118 into sorting flow path 116

S sample layer flow

P targeted sample

a1 first-level substrate layer

a2 second-level substrate layer

a3 third-level substrate layer

10 microparticle measuring device

101 light radiation unit

102 detection unit

1021 forward scatter detection unit

1022 fluorescence detection unit

1023 side scatter detection unit

1. A microfluidic device, comprising:
a microfluidic structure including a plurality of substrate layers, at least one of which includes a flow path through which a liquid containing microparticles may flow,
wherein the microfluidic structure includes a top surface, a bottom surface arranged opposite the top surface, a first side surface arranged between the top surface and the bottom surface, and a second side surface arranged opposite the first side surface, and
wherein the microfluidic structure includes an optical measurement region that includes an optical irradiation region at the first side surface that allows light irradiated on the optical irradiation region to interact with the microparticles when present in the flow path, a portion of the flow path, and an optical detection region at the second side surface.

2. The microfluidic device according to claim 1, wherein the microfluidic structure includes a first substrate layer and a second substrate layer having a bonding surface at which the first substrate layer and the second substrate layer are bonded, and
wherein the optical measurement region does not include the bonding surface.

3. The microfluidic device according to claim 2, wherein the bonding surface is arranged along a first direction from a first end of the plurality of substrate layers to a second end of the plurality of substrate layers, and
wherein along the first direction, the bonding surface includes at least one notch at the optical measurement region.

4. The microfluidic device according to claim 3, wherein the optical measurement region includes a light transmission path along a second direction orthogonal to the first direction.

5. The microfluidic device according to claim 3, wherein the at least one notch includes a first notch and a second notch, wherein the first and second notches have different shapes.

6. The microfluidic device according to claim 5, wherein the first notch is arranged at the first side surface and the second notch is arranged at the second side surface.

7. The microfluidic device according to claim 2, wherein within the optical measurement region, a thickness of the first substrate layer and/or the second substrate layer along a direction between the top and bottom surfaces is different than the thickness of the first substrate layer and/or the second substrate layer outside of the optical measurement region.

8. The microfluidic device according to claim 1, further comprising:
a reflector arranged to reflect forward scattering light within the optical measurement region.

9. The microfluidic device according to claim 8, wherein the reflector comprises a minor arranged at the second side surface.

10. The microfluidic device according to claim 9, wherein the mirror is arranged within the microfluidic structure at the second side surface.

11. The microfluidic device according to claim 9, wherein the optical measurement region includes a midline extending from the first side surface to the second side surface, and wherein the minor is arranged offset from the midline by a predetermined forward scattering angle.

12. The microfluidic device according to claim 1, wherein the microfluidic structure includes a first substrate layer and a second substrate layer having a bonding surface at which the first substrate layer and the second substrate layer are bonded, and
wherein along a direction perpendicular with the top surface, a distance of the bonding surface relative to the top surface changes.

13. A microparticle measuring device, comprising:
a light source configured to irradiate light on a first side surface of a microfluidic structure that includes a plurality of substrate layers, at least one of which includes a flow path through which a liquid containing microparticles may flow; and
a detector configured to detect a signal based, at least in part, on an interaction of the light with the microparticles when present in the liquid.

14. The microparticle measuring device according to claim 13, wherein the first side surface is parallel to the flow path in the microfluidic structure.

15. The microparticle measuring device according to claim 13, wherein the detector includes:
a forward scatter detector configured to detect forward scattering light, wherein the forward scatter detector is arranged facing the first side surface; and
a fluorescence detector configured to detect a fluorescence signal, wherein the fluorescence detector is arranged facing a surface of the microfluidic structure different from the first side surface.

16. The microparticle measuring device according to claim 15, wherein the first side surface is arranged between a top surface and a bottom surface of the microfluidic structure, and
wherein the forward scatter detector is arranged facing the top surface or the bottom surface.

17. The microparticle measuring device according to claim 13, wherein the detector includes:
a forward scatter detector configured to detect forward scattering light, and
a fluorescence detector configured to detect a fluorescence signal, and
wherein the forward scatter detector and the fluorescence detector are arranged facing different surfaces of the microfluidic device.

18. The microparticle measuring device according to claim 17, wherein the microfluidic structure further includes a reflector configured to reflect the forward scattering light, and
wherein the forward scatter detector is configured to detect the forward scattering light reflected by the reflector.

19. A microparticle measuring method comprising:
irradiating light on a side surface of a microfluidic structure that includes a plurality of substrate layers, at least one of which includes a flow path through which a liquid containing microparticles may flow; and
detecting a signal based, at least in part, on an interaction of the light with the microparticles when present in the liquid.
